(19) United States
(12) Patent Application Publication
(10) Pub. No.: US 2005/0200357 A1
(43) Pub. Date: Sep. 15, 2005

(54) Magnectic resonance imaging

(76) Inventors: Klaas Paul Pruessmann, Zurich (CH); Markus Weiger, Kressbonn (DE); Peter Boesiger, Ennetbaden (CH)

Correspondence Address: PHILIPS INTELLECTUAL PROPERTY & STANDARDS, 595 MINER ROAD, CLEVELAND, OH, 44143, US

(21) Appl. No.: 10/514,358

(22) PCT Filed: May 8, 2003
(86) PCT No.: PCT/IB03/01926

§ 371 Date: Nov. 12, 2004

(30) Foreign Application Priority Data
May 13, 2002 (EP) 02076845.3

(51) Int. Cl. G01V 3/00

(52) U.S. Cl. 324/309

(57) ABSTRACT

In a magnetic resonance imaging system the receiver antennae system includes receiver coils which are electromagnetically coupled with a relative coupling degree in the range (Δ, 0.5), preferably in the range (Δ, 0.2).

The invention relates to a magnetic resonance imaging method comprising
applying a static main magnetic field with a main field strength an acquisition sequence with an RF-excitation which generates an echo train of successive magnetic resonance signals from an object to be examined
receiving the magnetic resonance signals with a degree of undersampling and by means of a receiver antennae system having a spatial sensitivity profile and
reconstructing a magnetic resonance image from the magnetic resonance signals and the spatial sensitivity profile.

Such a magnetic resonance imaging system operates according to a method which is usually indicated as a parallel imaging method and is known from the paper by K. Pruessmann et al. in Magn. Reson. Med. 42(1999)952-962.

The known method is in particular known as the SENSE-technique. The undersampling of the magnetic resonance signals is associated with undersampling in the k-space and reduces the time required for scanning the k-space. However, parallel imaging methods generate magnetic resonance signals that intrinsically have a relative low signal-to-noise ratio (SNR). In particular, the SNR decreases with increasing degree of undersampling. The known method employs a receiver antennae system that includes several receiver coils, notably surface coils which are electromagnetically decoupled. To that end the in the known magnetic resonance system intricate electromagnetic measures have been taken to achieve the electromagnetic decoupling of the surface coils. The cited reference mentions that the signal-to-noise ratio (SNR) of the reconstructed image will be lowered due to electromagnetic coupling of the surface coils. Notably, geometry related noise enhancement in practice grows rapidly when the degree of undersampling, e.g. as represented by the SENSE reduction factor R approaches its theoretical maximum value beyond which maximum the reconstruction becomes underdetermined.

An object of the invention is to provide a magnetic resonance system in which the receiver antennae system is less complicated.

This object is achieved in a magnetic resonance imaging system according to the invention wherein the receiver antennae system includes receiver coils which are electromagnetically coupled with a relative coupling degree in the range (Δ, 0.5), preferably in the range (Δ, 0.2). The lower limit Δ is a lower limit of the relative coupling degree such that when coupling at or below the lower limit occurs, an magnetic resonance image of high diagnostic quality is obtained without taking the noise induced by coupling into account in the reconstruction, In practice Δ is in the range 0.02-0.05.
As a quantitative measure of the degree of relative coil coupling is defined as

$$‖ C - Id ‖ = \sqrt{{\sum }_{i , j} {\vert {C}_{i , j} - {δ}_{i , j} \vert}^{2}}$$

Where C is the coupling matrix (Size=Number of coils×Number of coils), Id is the corresponding identity matrix, δᵢⱼ is the Kronecker delta (1 for i=j, 0 else). So coupling is zero when the coupling matrix is equal to identity (i.e. the sensitivities remain unchanged). Otherwise the deviation from identity leads to non-zero coupling.

The invention is based on the insight that as a stronger relative coupling is allowed, less complicated (electronic and mechanical) construction of the receiver coils is made possible. In particular, a relatively large mutual inductive coupling among the receiver coils is allowed so that less electromagnetic isolation between the receiver coils is required. In particular according to the invention adequate results for the SNR are still achieved for a significant level of coupling as high as 0.1 or 0.2.

Furthermore, surprisingly it has appeared that the SNR of the reconstructed magnetic resonance image is substantially constant is the specified range. Moreover, this advantage remains substantially independent of both the degree of undersampling, such as the so-called SENSE-factor R and of the main field strength. In particular, the present invention can be applied successfully in 1.5T MRI systems as well as in 3T MRI systems.

In particular the reconstruction of the magnetic resonance image from the undersampled magnetic resonance signals involves a minimisation of noise correlation of magnetic resonance signals in different signal receipt channels. Such a minimisation notably is incorporated in the SENSE-technique. It appears the minimisation of the noise correlation in different signal receipt channels is able to compensate for the noise induced by the mutual electromagnetic coupling of the receiver coils.

The time required for acquisition of the magnetic resonance (MR) signals is reduced by employing sub-sampling of the MR-signals. Such sub-sampling involves a reduction in k-space of the number of sampled points which can be achieved in various ways. Notably, the MR signals are picked-up through signal channels pertaining to several receiver antennae, such as receiver coils, preferably surface coils. Acquisition through several; signal channels enables parallel acquisition of signals so as to further reduce the signal acquisition time.

Owing to the sub-sampling, sampled data contain contributions from several positions in the object being imaged. The magnetic resonance image is reconstructed from the sub-sampled MR-signals with the use of a sensitivity profile associated with the signal channels. Notably, the sensitivity profile is for example the spatial sensitivity profile of the receiver antennae, such as receiver coils. Preferably, surface coils are employed as the receiver antennae. The reconstructed magnetic resonance image may be considered as being composed of a large number of spatial harmonic components which are associated with brightness/contrast variations at respective wavelengths. The resolution of the magnetic resonance image is determined by the smallest wavelength, that is by the highest wavenumber (k-value).The largest wavelength, i.e. the smallest wavenumber, involved, is the field-of-view (FOV) of the magnetic resonance image. The resolution is determined by the ratio of the field-of-view and the number of samples.

The sub sampling may be achieved in that respective receiver antennae acquire MR signals such that their resolution in k-space is coarser than required for the resolution of the magnetic resonance image. The smallest wavenumber sampled, i.e. the minimum step-size in k-space, is increased while the largest wavenumber sampled is maintained. Hence, The image resolution remains the same when applying sub-sampling, while the minimum k-space step increases, i.e. the FOV decreases. The sub-sampling may be achieved by reduction of the sample density in k-space, for instance by skipping lines in the scanning of k-space so that lines in k-space are scanned which are more widely separated than required for the resolution of the magnetic resonance image. The sub-sampling may be achieved by reducing the field-of-view while maintaining the largest k-value so that the number of sampled points is accordingly reduced. Owing to the reduced field-of-view sampled data contain contributions from several positions in the object being imaged.

Notably, when receiver coil images are reconstructed from sub-sampled MR-signals from respective receiver coils, such receiver coil images contain aliasing artefacts caused by the reduced field-of-view. From the receiver coil images and the sensitivity profiles the contributions in individual positions of the receiver coil images from different positions in the image are disentangled and the magnetic resonance image is reconstructed. This MR-imaging method is known as such under the acronym SENSE-method. This SENSE-method is discussed in more detail in the international application no. WO 99/54746-A1.

Alternatively, the sub-sampled MR-signals may be combined into combined MR-signals which provide sampling of k-space corresponding to the full field-of-view. In particular, according to the so-called SMASH-method sub-sampled MR-signals approximate low-order spherical harmonics which are combined according to the sensitivity profiles. The SMASH-method is known as such from the international application no. WO 98/21600.

Sub-sampling may also be carried-out spatially. In that case the spatial resolution of the MR-signals is less than the resolution of the magnetic resonance image and MR-signals corresponding to a full resolution of the magnetic resonance image are formed on the basis of the sensitivity profile. Spatial sub-sampling is in particular achieved in that MR-signals in separate signal channels, e.g. from individual receiver coils, form a combination of contributions from several portions of the object. Such portions are for example simultaneously excited slices. Often the MR-signals in each signal channel form linear combinations of contributions from several portions, e.g. slices. This linear combination involves the sensitivity profile associated with the signal channels, i.e. of the receiver coils. Thus, the MR-signals of the respective signal channels and the MR-signals of respective portions (slices) are related by a sensitivity matrix which represents weights of the contribution of several portions of the object in the respective signal channels due to the sensitivity profile. By inversion of the sensitivity matrix, MR-signals pertaining to respective portions of the object are derived. In particular MR-signals from respective slices are derived and magnetic resonance images of these slices are reconstructed.

These and other aspects are further elaborated with reference to the detailed embodiments and with reference to the accompanying drawing wherein the various Figures show the following

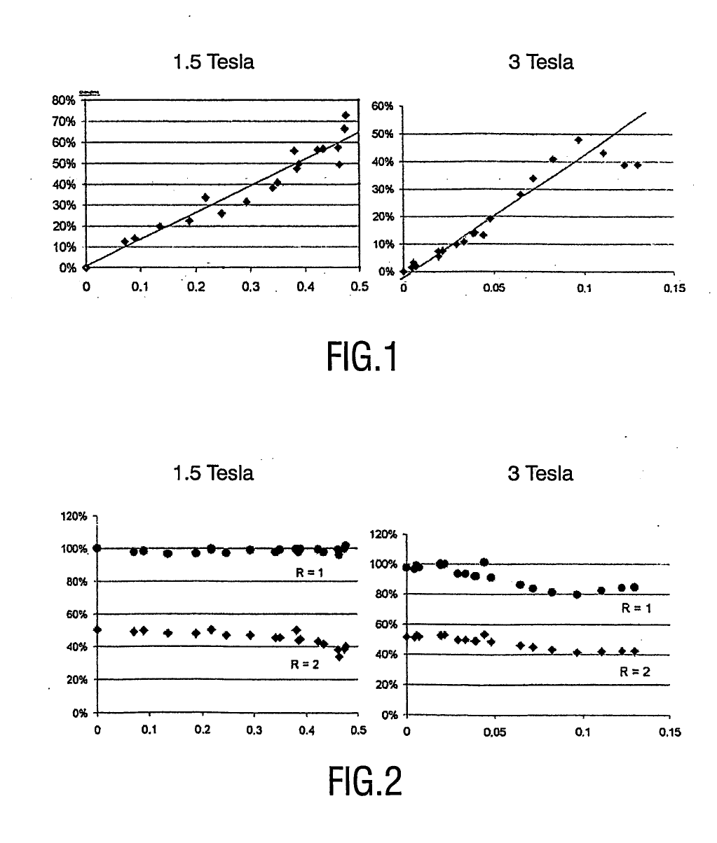

FIG. 1 shows the discrepancy between the scalar coupling and the actual overall coupling,

FIG. 2 shows the SNR in SENSE imaging as a function of the actual overall coupling,

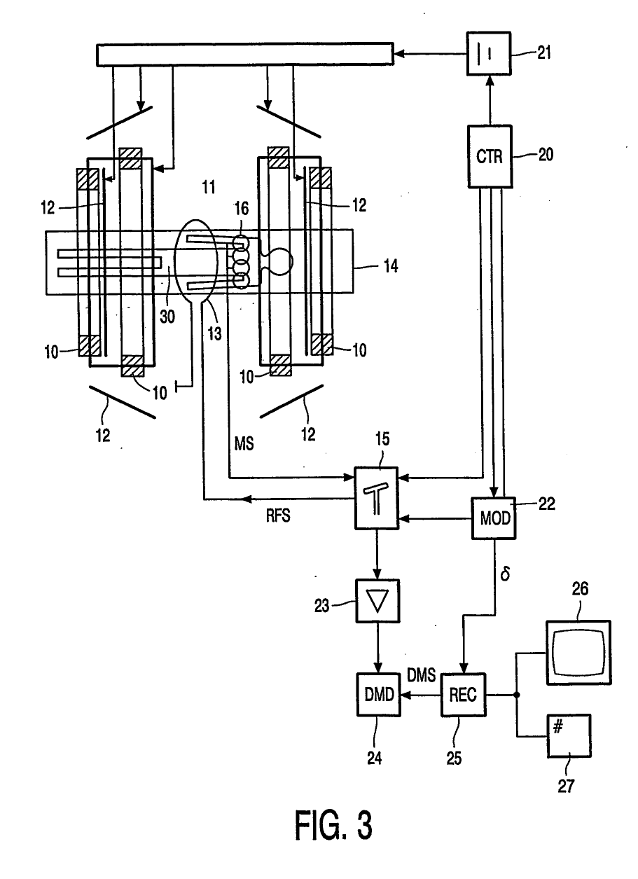

FIG. 3 shows diagrammatically a magnetic resonance imaging system in which the invention is used.

In this invention the impact of inductive coupling on the SNR performance of parallel imaging was investigated. SENSE imaging with variable coil coupling was performed at 1.5 and 3 Tesla. The results suggest that SNR in parallel imaging is not extremely sensitive to coupling, opposing concerns that coil sensitivities may irreversibly lose distinctness upon mutual signal transmission.

Introduction

Inductive coupling of array coil elements is known to have an adverse effect on the signal-to-noise ratio (SNR) in conventional phased array imaging. For parallel imaging with coil arrays, using, e.g., SMASH or SENSE , coil coupling should be expected to entail additional SNR loss as it renders the sensitivity profiles of the array elements more similar, potentially increasing geometry factors. However, if mutual coupling were essentially a scalar effect transmitting MR signal and stochastic noise in the same fashion, theory predicts the coupling effect to cancel out.

In this work we investigate coil coupling in parallel imaging based on the hypothesis of scalar mutual transmission, with special respect to the influence of field strength.

Theory and Methods

Due to finite impedance of coil circuits, noise voltages arising from thermal radiation of the object and coil resistance result in noise current, causing inductive coupling with neighboring coil elements. In a low frequency approximation, the induced voltage simply scales with mutual inductance. Hence in that regime noise and MR signal would transmit with two scalar weights specific for each coil pair. For an array of N_{C} coils, coupling could thus be described by a coupling matrix C of N_{C}×N_{C} scalars, permitting uncoupling by means of inverse linear combination. This may readily be illustrated by considering the image noise matrix resulting from Cartesian SENSE reconstruction:
X=(S^{H}Ψ⁻¹S)⁻¹, [1]
where S and Ψ denote the sensitivity and receiver noise matrices, respectively, and the superscript H denotes the complex conjugate transpose. In the scalar regime, coupling would simply modify S, Ψ as
S^{c}=CS, Ψ^{c}≈CΨC^{H}, [2]
where the superscript c denotes the coupled state. Inserting the modified terms in Eq. [b 1] shows that such coupling would leave the image noise level and thus SNR unaffected. In particular, conventional array imaging, corresponding to the SENSE with the reduction R=1, would not suffer from coil coupling.

However, the scalar coupling approximation cannot be expected to strictly hold in the frequency regime of MRI. In order to study its applicability, SENSE imaging experiments were conducted at 1.5 and 3 Tesla, using identical water phantoms and pairs of surface receiver coils of identical geometry (rectangular, 10 cm×20 cm, gap=3 cm). A standard gradient echo sequence was used for imaging on 1.5 T and 3 T whole-body Philips Intera Systems (Philips Medical Systems, Best, The Netherlands), using the body coil for RF transmission. Sensitivity maps were created from conventional reference scans; the receiver noise matrix was determined from additional acquisition without MR signal (flip angle=0). Variable coil coupling was induced by varying the coil current through slight, gradual alteration (20 steps) of a matching capacitance in the preamplifier circuit of one coil.

The default capacitance was used as a reference closest to coil isolation. For modified capacitance settings apparent coupling matrices C were determined from sensitivity maps by least-squares fitting. The norm deviation of C from identity was used as a measure of overall coupling, serving as the abscissa value in the Results section. The hypothesis of equal, scalar coupling of signal and noise was then tested by calculating the discrepancy between actual noise correlation and the expected values according to the previously assessed coupling matrices:
Discrepancy_{Ψ}=∥Ψ^{c}−CΨ^{ref} C^{H}∥/∥Ψ^{c}∥, [3]
where Ψ^{ref} is determined in the reference setting. Finally, for each capacitance setting the actual effect of coupling on SNR was assessed by SENSE imaging with reduction factors of R=1 and R=2.
Results

Signal coupling showed good compliance with the scalar coupling model, yielding normed fitting residua in the range of 3% (1.5 T) and 2% (3 T). Yet considerable discrepancy was observed between modeled and actual noise correlation as shown in FIG. 1. Note that at 3 T the discrepancy increases much more strongly as a function of overall coupling. FIG. 2 shows the mean SNR obtained by SENSE imaging with the capacitance varied, revealing good overall robustness of SNR against coupling, especially at R=1 and 1.5 T. Both 3 T series show increased SNR susceptibility at low overall coupling already.

Discussion

The results suggest that SNR in parallel imaging is not extremely sensitive to coil coupling. In this study the coil sensitivities showed approximately scalar coupling behavior, permitting the regeneration of virtual uncoupled coils in linear reconstruction. However the noise component showed significant, systematic deviation from the scalar coupling model, increasing strongly with frequency. A potential explanation is that alternating currents in an extended coil conductor contradict the assumption of a single scalar current. Thus, as coil current becomes a local quantity along the conductor, the electric nature of noise sources, as opposed to the magnetic signal sources, may result in increasingly different transmission pathways.

Steeper increase in discrepancy between signal and noise coupling at Tesla coincided with enhanced SNR penalty in SENSE imaging. This penalty, however, was fairly similar to that obtained with conventional array imaging, suggesting underlying mechanisms not specific to parallel imaging.

FIG. 3 shows diagrammatically a magnetic resonance imaging system in which the invention is used.

The magnetic resonance imaging system includes a set of main coils 10 whereby the steady, uniform magnetic field is generated. The main coils are constructed, for example in such a manner that they enclose a tunnel-shaped examination space. The patient to be examined is slid into this tunnel-shaped examination space. The magnetic resonance imaging system also includes a number of gradient coils 11, 12 whereby magnetic fields exhibiting spatial variations, notably in the form of temporary gradients in individual directions, are generated so as to be superposed on the uniform magnetic field. The gradient coils 11, 12 are connected to a controllable power supply unit 21. The gradient coils 11, 12 are energized by application of an electric current by means of the power supply unit 21. The strength, direction and duration of the gradients are controlled by control of the power supply unit. The magnetic resonance imaging system also includes transmission and receiving coils 13, 15 for generating the RF excitation pulses and for picking up the magnetic resonance signals, respectively. The transmission coil 13 is preferably constructed as a body coil whereby (a part of) the object to be examined can be enclosed. The body coil is usually arranged in the magnetic resonance imaging system in such a manner that the patient 30 to be examined, being arranged in the magnetic resonance imaging system, is enclosed by the body coil 13. The body coil 13 acts as a transmission aerial for the transmission of the RF excitation pulses and RF refocusing pulses. Preferably, the body coil 13 involves a spatially uniform intensity distribution of the transmitted RF pulses. The receiving coils 15 are preferably surface coils 15 which are arranged on or near the body of the patient 30 to be examined. Such surface coils 15 have a high sensitivity for the reception of magnetic resonance signals which is also spatially inhomogeneous. This means that individual surface coils 15 are mainly sensitive for magnetic resonance signals originating from separate directions, i.e. from separate parts in space of the body of the patient to be examined. The coil sensitivity profile represents the spatial sensitivity of the set of surface coils. The transmission coils, notably surface coils, are connected to a demodulator 24 and the received magnetic resonance signals (MS) are demodulated by means of the demodulator 24. The demodulated magnetic resonance signals (DMS) are applied to a reconstruction unit. The reconstruction unit reconstructs the magnetic resonance image from the demodulated magnetic resonance signals (DMS) and on the basis of the coil sensitivity profile of the set of surface coils. The coil sensitivity profile has been measured in advance and is stored, for example electronically, in a memory unit which is included in the reconstruction unit. The reconstruction unit derives one or more image signals from the demodulated magnetic resonance signals (DMS), which image signals represent one or more, possibly successive magnetic resonance images. This means that the signal levels of the image signal of such a magnetic resonance image represent the brightness values of the relevant magnetic resonance image. The reconstruction unit 25 in practice is preferably constructed as a digital image processing unit 25 which is programmed so as to reconstruct the magnetic resonance image from the demodulated magnetic resonance signals and on the basis of the coil sensitivity profile. The digital image processing unit 25 is notably programmed so as to execute the reconstruction in conformity with the so-called SENSE technique or the so-called SMASH technique. The image signal from the reconstruction unit is applied to a monitor 26 so that the monitor can display the image information of the magnetic resonance image (images). It is also possible to store the image signal in a buffer unit 27 while awaiting further processing, for example printing in the form of a hard copy.

In order to form a magnetic resonance image or a series of successive magnetic resonance images of the patient to be examined, the body of the patient is exposed to the magnetic field prevailing in the examination space. The steady, uniform magnetic field, i.e. the main field, orients a small excess number of the spins in the body of the patient to be examined in the direction of the main field. This generates a (small) net macroscopic magnetization in the body. These spins are, for example nuclear spins such as of the hydrogen nuclei (protons), but electron spins may also be concerned. The magnetization is locally influenced by application of the gradient fields. For example, the gradient coils 12 apply a selection gradient in order to select a more or less thin slice of the body. Subsequently, the transmission coils apply the RF excitation pulse to the examination space in which the part to be imaged of the patient to be examined is situated. The RF excitation pulse excites the spins in the selected slice, i.e. the net magnetization then performs a precessional motion about the direction of the main field. During this operation those spins are excited which have a Larmor frequency within the frequency band of the RF excitation pulse in the main field. However, it is also very well possible to excite the spins in a part of the body which is much larger than such a thin slice; for example, the spins can be excited in a three-dimensional part which extends substantially in three directions in the body. After the RF excitation, the spins slowly return to their initial state and the macroscopic magnetization returns to its (thermal) state of equilibrium. The relaxing spins then emit magnetic resonance signals. Because of the application of a read-out gradient and a phase encoding gradient, the magnetic resonance signals have a plurality of frequency components which encode the spatial positions in, for example the selected slice. The k space is scanned by the magnetic resonance signals by application of the read-out gradients and the phase encoding gradients. According to the invention, the application of notably the phase encoding gradients results in the sub-sampling of the k space, relative to a predetermined spatial resolution of the magnetic resonance image. For example, a number of lines which is too small for the predetermined resolution of the magnetic resonance image, for example only half the number of lines, is scanned in the k space.

1. A magnetic resonance imaging system comprising
a main magnet system for applying a static main magnetic field with a main field strength
an RF excitation system for generating an RF-excitation which generates one or several magnetic resonance signals from an object to be examined
a receiver antennae system having a spatial sensitivity profile for receiving the magnetic resonance signals with a degree of undersampling and by means of
reconstructing a magnetic resonance image from the magnetic resonance signals and the spatial sensitivity profile, wherein
the receiver antennae system includes receiver coils which are electromagnetically coupled with a relative coupling degree in the range (Δ, 0.5), preferably in the range (Δ, 0.2).

2. A magnetic resonance imaging system as claimed in claim 1, wherein
the receiver antennae system comprises several receiver antennae which are coupled to respective signal receipt channels and
reconstruction of the magnetic resonance image involves a minimisation of noise correlation of magnetic resonance signals in different signal receipt channels.
